(19) United States
(12) Patent Application Publication
(10) Pub. No.: US 2018/0061103 A1
(43) Pub. Date: Mar. 1, 2018

(54) Systems and Methods for Generating Display Views Tracking User Head Movement for Head-Mounted Display Devices

(71) Applicant: Analogix Semiconductor, Inc., Santa Clara, CA (US)

(72) Inventor: Ning Zhu, San Jose, CA (US)

(21) Appl. No.: 15/666,357

(22) Filed: Aug. 1, 2017

Related U.S. Application Data
(60) Provisional application No. 62/380,961, filed on Aug. 29, 2016.

(51) Int. Cl. G06T 11/60; G09G 5/00

(52) U.S. Cl. CPC G06T 11/60; G09G 5/003; G09G 2354/00; G09G 2300/02; G09G 2340/14

(57) ABSTRACT

Provided are systems and methods for generating display views tracking user head movement for head-mounted display (HMD) devices. An exemplary method may include receiving, at the HMD device, a display image from a source device. In response to movement of the head of a user wearing the HMD device, the method may include generating, at the HMD device, video offset data via at least one motion sensor in the HMD device. The method may further include applying, at the HMD device, the video offset data to the display image to generate the display view. In various embodiments, the display view is smaller than, and a subset of, the display image. The method may include presenting, by the HMD device, the display view to the user.

### CROSS-REFERENCE TO RELATED APPLICATIONS

The present application claims the benefit of U.S. Provisional Application No. 62/380,961, filed Aug. 29, 2016, which is incorporated herein by reference for all purposes.

### FIELD

The present application relates to head-mounted display devices, and more specifically to systems and methods for generating display views tracking user head movement.

### BACKGROUND

Approaches described in this section should not be assumed to qualify as prior art merely by virtue of their inclusion therein.

Conventional systems for Virtual Reality (VR) and/or Augmented Reality (AR) typically have a conventional arrangement that includes a conventional video source device coupled to a conventional head-mounted display (HMD) device mounted to a user's head. These conventional systems may detect user head movement in the HMD device, utilize the video source device to compute and adjust the display view based on the movement, and then send this adjusted display view from the video source device to the HMD device to provide displays to each of the user's eyes. These conventional systems place substantial demands on the video source device (e.g., typically on its graphics processing unit (GPU)) in terms of performance and power, and, at the same time, may not provide acceptable latency for the user when the user moves his or her head while using the HMD device.

### SUMMARY

This summary is provided to introduce a selection of concepts in a simplified form that are further described below in the Detailed Description. This summary is not intended to identify key features or essential features of the claimed subject matter, nor is intended to be used as an aid in determining the scope of the claimed subject matter.

The systems and methods according to various embodiments of the present technology may effectively reduce rendering latency of the display view and reduce the performance requirement for the GPU on the video source device side to achieve desirable virtual reality and/or augmented reality user experiences.

Disclosed are systems and methods for generating display views that track head movement of a user of a head-mounted display (HMD) device. In some embodiments, a method for generating a display view for an HMD device includes receiving, at the HMD device, a display image from a source device. The method may include, in response to movement of the head of a user wearing the HMD device, generating, at the HMD device, video offset data via at least one motion sensor in the HMD device. The video offset data may be applied, at the HMD device, to the display image to generate the display view. In various embodiments, the display view is smaller than, and a subset of, the display image. The method may further include presenting the display view to the user (or configuring the display view for visual presentation to the user).

In certain embodiments, a method for generating a display image for an HMD device includes generating, by a source device, a display image for the HMD device. The method may include sending, from a source device, a first display image having a first display image boundary to the HMD device, and receiving, at the source device, movement data from the HMD device in response to movement of the head of a user wearing the HMD device. The method may also include determining, at the source device, that based on the data, the movement would cause the user's view to be outside of the display image boundary. In response to the determination, the method may further include generating, at the source device, a second display image having a second, different display image boundary. The method may further include sending, from the source device, the second display image to the HMD device.

In some embodiments, an HMD device wearable by a user includes at least one motion sensor configured to generate video offset data in response to movement of the head of the user; and a pixel data generator that receives a display image from a source device and generates a display view (e.g., in the form of pixel data) from both the display image and the video offset data, the display view being smaller than, and a subset of, the display image. In various embodiments, the HMD also includes circuitry for configuring the display view for viewing by the user wearing the HMD device.

The systems and methods may generate the display view, which tracks the head movement of a user when wearing the HMD device. The systems and methods may generate the new display views for left-eye and right-eye displays by applying the video offset on horizontal and vertical directions of the incoming display image, and extracting the correct display views from the display image. Accordingly, the systems and methods can effectively reduce rendering latency for the display views, and lower the performance and power requirements for a graphics processing unit (GPU) of the source device for achieving desirable VR and AR user experiences.

Other example embodiments of the disclosure and aspects will become apparent from the following description taken in conjunction with the following drawings.

### BRIEF DESCRIPTION OF DRAWINGS

Embodiments are illustrated by way of example and not limitation in the figures of the drawings, in which like references indicate similar elements.

FIG. 1 is a block diagram of an exemplary architecture for a head-mounted display (HMD) device coupled to a source device.

FIG. 2 is a diagram illustrating a display image and a display view in a head-mounted display application for the exemplary architecture of FIG. 1.

FIG. 3 is a block diagram of another exemplary architecture for a head-mounted display device, that is coupled to a source device and determines video offset data based on user head movement, according to another example embodiment.

FIG. 4 is a diagram illustrating the generation of a new display view based on the video offset data of FIG. 3.

FIG. 5 is a computer system which can be used (e.g., for the video source device) to implement certain embodiments for the present technology.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

The technology disclosed herein relates to systems and methods for generating a display view that tracks head movement of a user when the user is wearing a head-mounted display (HMD) device. In various embodiments, the systems and methods provide for generation of left-eye and right-eye display views for left-eye and right-eye displays, respectively, by applying a video offset on horizontal and/or vertical directions of the incoming display image and extracting the display views from the display image.

Other systems and method may track user head movement in the HMD device, and use the video source device to adjust the display view. These other systems place substantial demands on the graphics processing unit (GPU) in the video source device to adjust the display view in the video source device before the adjusted display view is sent to the HMD device. For these other systems, this can result in undesirable latency being experience by the user when the user moves his or her head, while at the same time requiring more power and performance for the video display source and its GPU. As a result, these other systems can exhibit undesirable latency, undesirable power demands and provide an undesirable user experience when the user moves the user's head. The systems and methods according to various embodiments can effectively reduce rendering latency of the display view and reduce the performance requirement for the GPU on the source side to achieve desirable VR/AR user experiences.

In general, in order to provide a very desirable VR/AR user experience, there should be low image rendering latency after the user moves his or her head (normally the low image rendering latency should be less than 20 ms to avoid the user experiencing undesirable lag in the update of the image), a high video refresh rate (should be greater than 60 hz to avoid flicker), and a high video resolution on each eye (should be greater than Full High Definition (FHD) 1080p resolution). Each of these factors puts a high demand on GPU performance, and hence, raises the cost of the GPU and, in turn, VR/AR capable mobile devices, like smartphones or tablets, and personal computing devices.

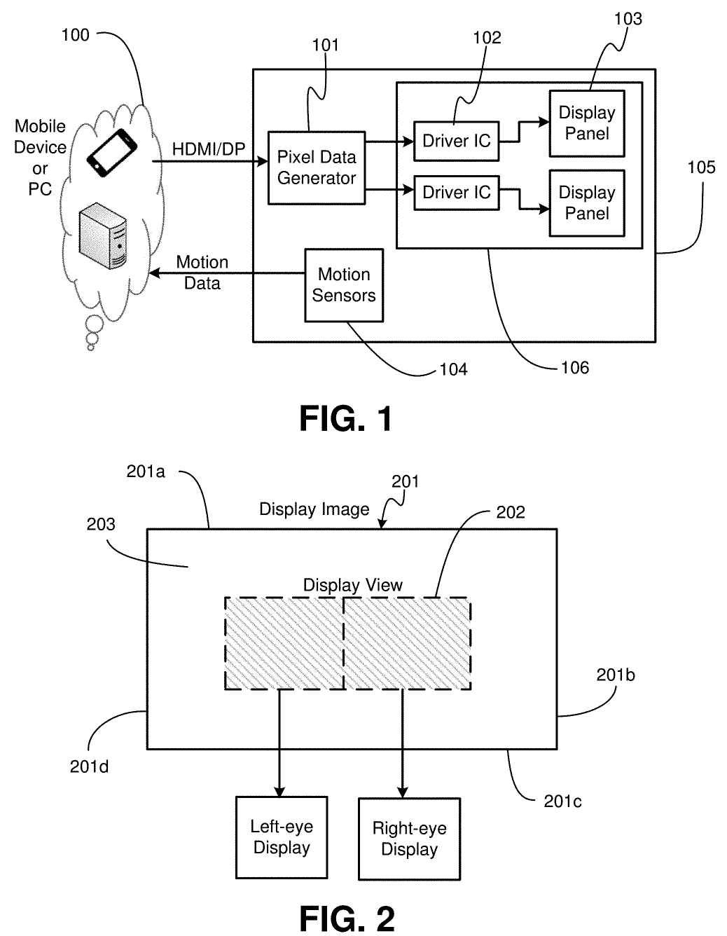

FIG. 1 shows a block diagram of an exemplary HMD 105 coupled to a source device 100. The source device 100 (also referred to herein as video source device 100) can be any suitable device that provides a video output, e.g., a mobile device or PC, to name a few. The video source device 100 and the HMD 105 may be coupled via a suitable video interface such as High-Definition Multimedia Interface (HDMI), DisplayPort (DP), or Type-C (with DisplayPort over Type-C enabled). The HMD 105 may comprise a pixel data generator 101, one or more motion sensors 104, and circuitry 106. In the example in FIG. 1, the circuitry 106 includes two driver integrated circuits (IC) 102 and two display panels 103.

The pixel data generator 101 may receive video data from the video source device 100. The pixel data generator 101 may provide a video data output to the driver ICs 102, which, in turn, may drive the display panels 103 to distribute output video data to a left-eye display and a right-eye display respectively. In some embodiments, the interface between the driver IC 102 and the respective display panel 103 is Mobile Industry Processor Interface (MIPI). However, it is to be understood that the interface may be other suitable valid protocols.

In the example in FIG. 1, the motion sensors 104 are embedded in the HMD 105 to track the movement of the body of the user. The motion sensors 104 may include one or more accelerometers, gyroscopes, or other suitable devices that detect motion. In response to a wearer of the HMD device moving his or her head, the one or more motion sensors 104 may detect the movement data, may record the detected movement data, and may send the movement data back to the source device 100. In this example, the video source device 100 would then render the new display view and send it to the HMD 105 for display to the user.

For the example in FIG. 1, the video source device 100 (e.g., its GPU) generates the display view whenever the user moves his or her head, even if the whole display image remains the same.

FIG. 2 is a diagram illustrating a display image and a display view in a head-mounted display application for the exemplary architecture of FIG. 1. More specifically, FIG. 2 depicts the relationship between the display image 201 and the display view 202. In various embodiments, the display view 202 is the view the user can see through the HMD 105 at each given moment. The display image 201 can include the display view 202 plus an additional portion 203 of the video source. In the example in FIG. 2, the additional portion 203 is between the display view 202 and certain boundaries 201a-201d. The display view 202 may always be a subset of the display image 201. In the examples in FIGS. 1 and 2, the actual display data that the source device 100 transfers to the HMD 105 is the display view 202.

The approach in the examples in FIGS. 1 and 2 impose substantial challenges to the GPU processing performance of the source device 100. The primary reason is that, for those examples, the GPU of the source device 100 needs to respond to every head movement of the user who is wearing the HMD 105 and render the new display views 202 accordingly, even when the display image 201 remains the same. The approach in the examples in FIGS. 1 and 2 may also increase the power consumption of the GPU in the source device 100 when the HMD 105 is connected with the source device 100. Furthermore, there is also the round-trip delay (e.g., from the motion sensors 104 to the source device 100 to the pixel data generator 101) that occurs from when the user moves his or her head to when the new display view shows up on the displays 103. The present disclosure describes systems and methods which can track head movement and adjust the view for the user, while lowering the performance and power requirements placed upon the source device.

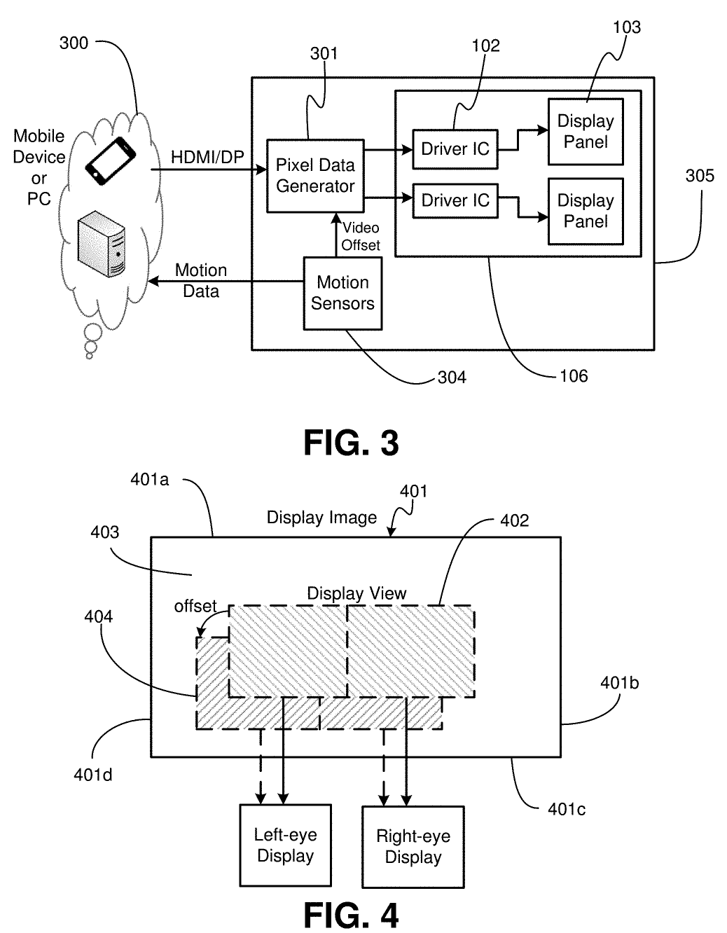

FIG. 3 is a block diagram of an exemplary architecture for a head-mounted display device 305, that is coupled to a source device 300 and determines and processes video offset data based on user head movement, according to another example embodiment. The source device 300 may be an example embodiment of the video source device 100 in FIG. 1, and thus can be any suitable device that provides a video output, e.g., a mobile device or PC, to name a few. In various embodiments, the head-mounted display 305 comprises a pixel data generator 301, motion sensors 304, and the circuitry 106 including the first and the second driver IC 102 and the first and the second display panel 103.

In one or more embodiments, instead of sending only the display view each time a screen image is refreshed, the source device 300 sends the whole display image, or a partial image, which is larger than the actual display view. The determining of whether to send the whole display image or partial image may depend on the available bandwidth of the link between the source device 300 and the pixel data generator 301, as well as the processing power of the GPU of the source device 300. In various embodiments, the pixel data generator 301 receives the display image from the source device 300. The pixel data generator 301 may then generate the display view, at least in part, from the display image, as will be explained in further detail below.

Although 304 is referred to as motion sensors, there may be one or more motion sensors for those elements. The motion sensors 304 may include one or more accelerometers, gyroscopes, or other suitable sensors that detect motion, in addition to at least one processor coupled to memory. The motion sensors 304 differ from the motions sensors 104 in the example in FIG. 1 in key respects. In various embodiments, in addition to detecting movement of a user (e.g., the user's head), the motion sensor may record the detected movement and also generate video offset data. In various embodiments, the video offset data represents a change (e.g., in horizontal and/or vertical distance, angular rotation, and the like) from a previous position to a current position. The motion sensors 304 may send the video offset data (identified as “Video Offset” in the example in FIG. 3) to the pixel data generator 301.

In various embodiments, the pixel data generator 301 differs from the pixel data generator 101 in various respects. The pixel data generator 301 may be configured to receive the video offset data from the motion sensors 304. The video offset data may be transferred physically from the motion sensors 304 to the pixel data generator 301 through a digital interface, e.g., a Serial Peripheral Interface (SPI) interface or a Universal Serial Bus (USB) interface, to name a few. The pixel data generator 301 may also be configured to apply the video offset data to the received display image, and to generate the new display view therefrom. In various embodiments, the pixel data generator 301 (also referred to as the generator herein) provides pixel data, for the new display view, to the driver ICs 102, which, in turn, drive the display panels 103 to provide output video data to a left-eye display and a right-eye display respectively, for viewing by a user.

FIG. 4 shows an example new display view 404, which may be generated within the same display image 401 based on the video offset data from the motion sensors 304. In various embodiments, the new display view 404 is determined based on the video offset data and the position of the previous display view 402. In this example, the previous display view 402 represents the display view prior to the movement of the user's head.

In the example in FIGS. 3 and 4, the actual display data that the source device 300 transfers to the HMD 305 is the display image 401. The display image 401 comprises one portion (e.g., the portion of the image from the video source that corresponds to the new display view 404 determined by the pixel data generator 301), plus an additional portion 403 of the video source. The additional portion 403 is between the display view 404 and certain boundaries 401a-401d. The display view 402, 404 may always be a subset of the display image 401.

In various embodiments, the motion sensors 304 send the movement data to the source device 300, which, in turn, determines if such movement would cause the user's view to exceed the boundary 401a-401d of the previously transferred display image 401. In various embodiments, the movement data sent to the source device 300 may include, for example, the video offset data, the change in raw motion sensor data, or the absolute raw motion sensor data. The kind of data may depend on the agreement between the source device and HMD for the particular implementation. In various embodiments, if the movement would cause the view to exceed the previously transferred display image boundary 401a-401d, the source device 300, generates a new display image with new display image boundaries and transfers the new display image to the pixel data generator 301. Otherwise, if the movement of the user's head that the motion sensors 304 detect would result in the user's view remaining within the previously transferred display image boundary 401a-401d, the source device 300 does not need to generate a new display image based on the user's head movement, saving resources of the source device 300.

In other embodiments, the motion sensors 304 (or alternatively the pixel data generator 301) may determine if such movement would cause the user's view to exceed the boundary 401a-401d of the previously transferred display image 401. Based on the determination that the movement would cause the view to exceed the previously transferred display image boundary 401a-401d, the motion sensors 304 (or alternatively the pixel display generator 301) sends a request to the source device 300 for a new display image. The request may include movement data, such as the video offset data, the change in raw motion sensor data, or the absolute raw motion sensor data. In response to the request, the source device 300 generates a new display image with new display image boundaries and transfers the new display image to the pixel data generator 301.

In certain embodiments, the source device 300 generates and transfers image offset data to the pixel data generator 301, the image offset data representing an offset between the previous and new display image. The pixel data generator 301 may then generate, based on the image offset data, a new display view which corresponds to the video offset data and the new display image. Alternatively, the source device 300 may generate the new display view based on the video offset data and new display image, and transfer the new display view to the pixel data generator 301.

In various embodiments, the resources saved (e.g., by having the pixel data generator 301 using video offset data generated by the motion sensors 304 in HMD 305 as in the examples in FIGS. 3 and 4) can allow, for example, the GPU of the source device 300 to have more time for generating the next display image, if necessary, or allow more idle time. In other words, according to various embodiments, the “local computing” in the HMD 305 by the motion sensors 304 and the pixel data generator 301 effectively reduces the burden on the source device 300 and hence, reduces the power consumption and performance requirements for the source device 300. The systems and methods according to various embodiments may also reduce the latency for the user experience, at least because having the processing of the update to the display view, in response to the user's head movement, be within the HMD 305, using the device offset instead of within the source device 300 avoids the round-trip processing path from the motion sensors 304 to the source device 300 and then from source device 300 to the HMD 305.

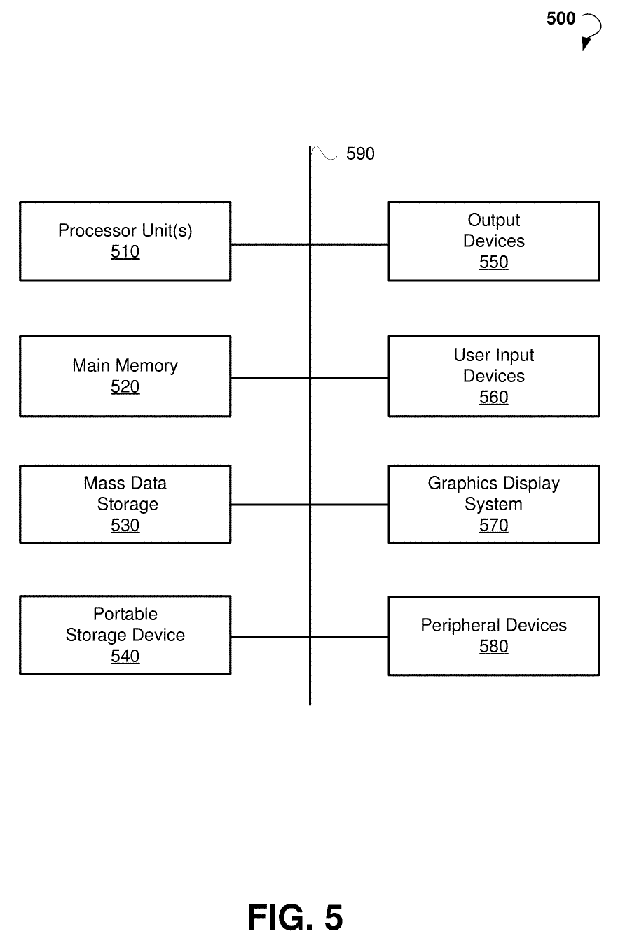

FIG. 5 illustrates an exemplary computer system 500 that may be used to implement various source devices according to various embodiments of the present disclosure. The computer system 500 of FIG. 5 may be implemented in the contexts of the likes of computing systems, networks, servers, or combinations thereof. The computer system 500 of FIG. 5 includes one or more processor unit(s) 510 and main memory 520. Main memory 520 stores, in part, instructions and data for execution by processor unit(s) 510. Main memory 520 stores the executable code when in operation, in this example. The computer system 500 of FIG. 5 further includes a mass data storage 530, portable storage device 540, output devices 550, user input devices 560, a graphics display system 570, and peripheral devices 580.

The components shown in FIG. 5 are depicted as being connected via a single bus 590. The components may be connected through one or more data transport means. Processor unit(s) 510 and main memory 520 are connected via a local microprocessor bus, and the mass data storage 530, peripheral devices 580, portable storage device 540, and graphics display system 570 are connected via one or more input/output (I/O) buses.

Mass data storage 530, which can be implemented with a magnetic disk drive, solid state drive, or an optical disk drive, is a non-volatile storage device for storing data and instructions for use by processor unit(s) 510. Mass data storage 530 stores the system software for implementing embodiments of the present disclosure for purposes of loading that software into main memory 520.

Portable storage device 540 operates in conjunction with a portable non-volatile storage mediums (such as a flash drive, compact disk, digital video disc, or USB storage device, to name a few) to input and output data/code to and from the computer system 500 of FIG. 5. The system software for implementing embodiments of the present disclosure is stored on such a portable medium and input to the computer system 500 via the portable storage device 540.

User input devices 560 can provide a portion of a user interface. User input devices 560 may include one or more microphones; an alphanumeric keypad, such as a keyboard, for inputting alphanumeric and other information; or a pointing device, such as a mouse, a trackball, stylus, or cursor direction keys. User input devices 560 can also include a touchscreen. Additionally, the computer system 500 as shown in FIG. 5 includes output devices 550. Suitable output devices 550 include speakers, printers, network interfaces, and monitors.

Graphics display system 570 include a liquid crystal display (LCD) or other suitable display device. Graphics display system 570 is configurable to receive textual and graphical information and process the information for output to the display device.

Peripheral devices 580 may include any type of computer support device to add additional functionality to the computer system.

The components provided in the computer system 500 of FIG. 5 are those typically found in computer systems that may be suitable for use with embodiments of the present disclosure and are intended to represent a broad category of such computer components that are well known in the art. Thus, the computer system 500 of FIG. 5 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN and other suitable operating systems.

The processing for various embodiments may be implemented in software that is cloud-based. In some embodiments, the computer system 500 is implemented as a cloud-based computing environment. In other embodiments, the computer system 500 may itself include a cloud-based computing environment. Thus, the computer system 500, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices.

The cloud may be formed, for example, by a network of web servers that comprise a plurality of computing devices, such as the computer system 500, with each server (or at least a plurality thereof) providing processor and/or storage resources. These servers may manage workloads provided by multiple users (e.g., cloud resource customers or other users).

While the present technology is susceptible of embodiment in many different forms, there is shown in the drawings and herein described in detail several specific embodiments with the understanding that the present disclosure is to be considered as an exemplification of the principles of the technology and is not intended to limit the technology to the embodiments illustrated.

1. A method for generating a display view for a head-mounted display (HMD) device, the method comprising:
receiving, at the HMD device, a display image from a source device;
in response to movement of the head of a user wearing the HMD device, generating, at the HMD device, video offset data via at least one motion sensor in the HMD device; and
applying, at the HMD device, the video offset data to the display image to generate the display view, the display view being smaller than, and a subset of, the display image.

2. The method of claim 1, further comprising presenting the display view to the user.

3. The method of claim 1, wherein the video offset data represents a horizontal and a vertical change in distance.

4. The method of claim 1, wherein the generating the display view is based on the video offset data and a previous display view.

5. The method of claim 1, further comprising determining whether the movement of the head of the user wearing the HMD device would cause the display view to exceed a boundary of the display image.

6. The method of claim 5, further comprising:
based on the determination that the movement of the head of the user wearing the HMD device would cause the display view to exceed a boundary of the display image, sending a request for a new display image to the source device; and
receiving the new display image from the source device.

7. The method of claim 1, further comprising:
sending movement data from the HMD device to the source device; and
if the movement of the head of the user wearing the HMD device would cause the display view to exceed a boundary of the display image, receiving a new display image from the source device.

8. A method for generating a display image for a head-mounted display (HMD) device, the method comprising:
sending, by a source device, a first display image having a first display image boundary to the HMD device;
at the source device, receiving data from the HMD device in response to movement of the head of a user wearing the HMD device, the data being associated with the movement;
at the source device, determining, based on the data, that the movement would cause a user's view to be outside of the first display image boundary;
based on the determining, generating, at the source device, a second display image having a second display image boundary; and
sending, from the source device, the second display image to the HMD device.

9. The method of claim 8, wherein the received data includes at least one of video offset data, a change in raw motion sensor data, and absolute raw motion sensor data.

10. The method of claim 9, wherein the video offset data represents a horizontal and a vertical change in distance.

11. The method of claim 8, further comprising:
based on the determining, generating, at the source device, a display view based on the second display image and the received data; and
sending, from the source device, the display view to the HMD device.

12. The method of claim 8, further comprising:
sending, from the source device, image offset data to the HMD device, wherein the image offset data represents an offset between the first display image and the second display image.

13. A head-mounted display (HMD) device wearable by a user, the HMD device comprising:
at least one motion sensor configured to generate video offset data in response to movement of the head of the user;
a pixel data generator for receiving a display image from a source device and generating a display view from the display image and the video offset data, the display view being smaller than, and a subset of, the display image; and
circuitry for configuring the display view for viewing by the user wearing the HMD device.

14. The HMD device of claim 13, wherein the display view is generated based on the video offset data and a previous display view.

15. The HMD device of claim 13, wherein the video offset data represents a horizontal and a vertical change in distance.

16. The HMD device of claim 13, wherein the display view includes pixel data generated by the pixel data generator.

17. The HMD device of claim 13, wherein the at least one motion sensor and the pixel data generator are coupled via a digital interface.

18. The HMD device of claim 17, wherein the digital interface is a Serial Peripheral Interface (SPI) interface or a Universal Serial Bus (USB) interface.

19. The HMD device of claim 13, wherein the circuitry includes two driver integrated circuits and two display panels.

20. The HMD device of claim 13, wherein the at least one motion sensor is further configured to send the video offset data to the source device.
